(19) United States
(12) Patent Application Publication
(10) Pub. No.: US 2010/0126271 A1
(43) Pub. Date: May 27, 2010

(54) INERTIAL VELOCITY SENSOR SIGNAL PROCESSING CIRCUIT AND INERTIAL VELOCITY SENSOR DEVICE INCLUDING THE SAME

(76) Inventors: Fumihito Inukai, Kyoto (JP); Hitoshi Kobayashi, Osaka (JP)

Correspondence Address: MCDERMOTT WILL & EMERY LLP, 600 13TH STREET, NW, WASHINGTON, DC, 20005-3096, US

(21) Appl. No.: 12/599,008

(22) PCT Filed: Oct. 30, 2008
(86) PCT No.: PCT/JP2008/003117

§ 371 Date: Nov. 5, 2009

(30) Foreign Application Priority Data
Jan. 8, 2008 (JP) 2008-001243

(51) Int. Cl. G01C 19/56

(52) U.S. Cl. 73/504.12

(57) ABSTRACT

An inertial velocity sensor signal processing circuit (12, 13, 14) used together with an inertial velocity sensor element (11) includes a first signal processing circuit (12, 13) which operates with a first clock (CLK1) and a second signal processing circuit (14) which operates with a second clock (CLK2) which does not synchronize with the first clock.

### TECHNICAL FIELD

The present invention relates to an inertial velocity sensor signal processing circuit used together with an inertial velocity sensor for detecting an inertial velocity, and an inertial velocity sensor device including the inertial velocity sensor signal processing circuit.

### BACKGROUND ART

Inertial velocity sensors, such as angular velocity sensors and acceleration sensors, are used in a wide variety of fields including hand movement detection for digital cameras, attitude control for mobile units (such as aircrafts, automobiles, robots, and ships) and the guidance of missiles and spacecraft. In recent years, as a result of development in circuit microfabrication techniques, progress is being made in the digitalization of an inertial force detection circuit for detecting an inertial force based on a signal from a sensor device. An example inertial force detection circuit that is configured using a digital circuit is disclosed in Japanese Laid-Open Patent Application Publication No. 2002-188925 (Patent Document 1). In the technique disclosed in Patent Document 1, a signal according to an inertial force from a sensor device is converted into a digital signal by an analog/digital circuit. At the same time, a square-wave signal corresponding to an oscillation frequency is generated by an oscillator circuit, and by using the square-wave signal, an inertial force component is detected from the digital signal. The digitalization of the inertial force detection circuit can reduce influences of offset voltage variations, which are typical of analog signals, and enhance accurate detection of the inertial force.

As in the above, high detection accuracy is required in inertial velocity sensor devices, and at the same time, failure detection is also important. Japanese Patent No. 2728300 (Patent Document 2) discloses an inertial velocity sensor device having a built-in testing function for detecting failures. In this inertial velocity sensor device, a signal for detecting failures is generated based on an oscillation frequency of a drive circuit by using a demodulator; the output of the demodulator is integrated by an integrator; and the output of the integrator is monitored to detect a failure condition.

### Patent Document 1: Japanese Laid-Open Patent Application Publication No. 2002-188925

### Patent Document 2: Japanese Patent No. 2728300

### DISCLOSURE OF INVENTION

### Problems to be solved by the invention

In the inertial velocity sensor device disclosed in Patent Document 2, however, an operation clock signal for detecting failures is generated based on a frequency of an inertial velocity sensor element, and thus, in the case where the inertial velocity sensor element is not in the normal operation, failure detection is impossible.

An object of the present invention is to provide a circuit capable of detecting an abnormal condition even if the inertial velocity sensor element is not in the normal operation.

### Means for solving the problems

According to an aspect of the present invention, an inertial velocity sensor signal processing circuit is used together with an inertial velocity sensor element and includes a first signal processing circuit which operates with a first clock and a second signal processing circuit which operates with a second clock which does not synchronize with the first clock. In the above inertial velocity sensor signal processing circuit, the second signal processing circuit operates with the second clock which does not synchronize with the first clock, and therefore, the second signal processing circuit can operate even when the first clock is in an abnormal condition.

It is preferable that the first clock is supplied from a first oscillator circuit which operates based on a frequency of the inertial velocity sensor element. In the above inertial velocity sensor signal processing circuit, the second signal processing circuit can operate even when the inertial velocity sensor element is not in the normal operation.

It is preferable that the inertial velocity sensor signal processing circuit further includes a clock input terminal to which the second clock is supplied, wherein the second signal processing circuit receives the second clock supplied to the clock input terminal. Alternatively, the inertial velocity sensor signal processing circuit further includes a second oscillator circuit configured to supply the second clock, wherein the second signal processing circuit receives the second clock from the second oscillator circuit.

According to another aspect of the present invention, an inertial velocity sensor device includes the inertial velocity sensor signal processing circuit and the inertial velocity sensor element.

It is preferable that in the inertial velocity sensor device, the second signal processing circuit outputs an abnormal condition detection signal when the second signal processing circuit detects an abnormal condition of the inertial velocity sensor device. In the inertial velocity sensor device, the second signal processing circuit can detect an abnormal condition of the inertial velocity sensor device even when the inertial velocity sensor element is not in the normal operation.

It is preferable that the inertial velocity sensor device further includes an abnormal condition handling circuit controlled by the abnormal condition detection signal, wherein the abnormal condition handling circuit operates with the second clock. In the inertial velocity sensor circuit, the abnormal condition handling circuit can operate even when the inertial velocity sensor element is not in the normal operation.

### EFFECTS OF THE INVENTION

As described in the above, the abnormal condition of an inertial velocity sensor device can be detected even if an inertial velocity sensor element is not in the normal operation.

### BRIEF DESCRIPTION OF DRAWINGS

FIG. 1 shows a configuration of an inertial velocity sensor device according to Embodiment 1 of the present invention.

FIG. 2 shows an example configuration of an inertial velocity sensor element of FIG. 1.

FIG. 3 shows an example internal configuration of a drive circuit of FIG. 1.

FIG. 4 shows an example internal configuration of an inertial force detection circuit of FIG. 1.

FIG. 5 shows an example internal configuration of an abnormal condition detection circuit of FIG. 1.

FIG. 6 shows a configuration of an inertial velocity sensor device according to Embodiment 2 of the present invention.

FIG. 7 shows an example internal configuration of an inertial force detection circuit of FIG. 6.

FIG. 8 shows a modification of the inertial force detection circuit of FIG. 6.

FIG. 9 shows a configuration of an inertial velocity sensor device according to Embodiment 3 of the present invention.

### DESCRIPTION OF CHARACTERS

11 inertial velocity sensor element
12 drive circuit
13 inertial force detection circuit
14 abnormal condition detection circuit
15 CR oscillator
101 monitor amplifier
102 automatic gain control (AGC) amplifier
103 drive amplifier
104 comparator
105 input amplifier
106 synchronous detector
107 low-pass filter
108 output amplifier
141, 142 comparators
143 NAND circuit
144 counter
21 PLL circuit
22 inertial force detection circuit
201 input amplifier
202 low-pass filter
203 analog/digital converter
204 synchronous detector
205 digital filter
206 output controller
31 temperature monitoring circuit
32 EEPROM
33 control circuit

### EXAMPLE EMBODIMENT

Embodiments of the present invention will be described in detail below, with reference to the drawings. In the drawings, like reference characters have been used to designate identical or equivalent elements, and explanation thereof is not repeated.

### Embodiment 1

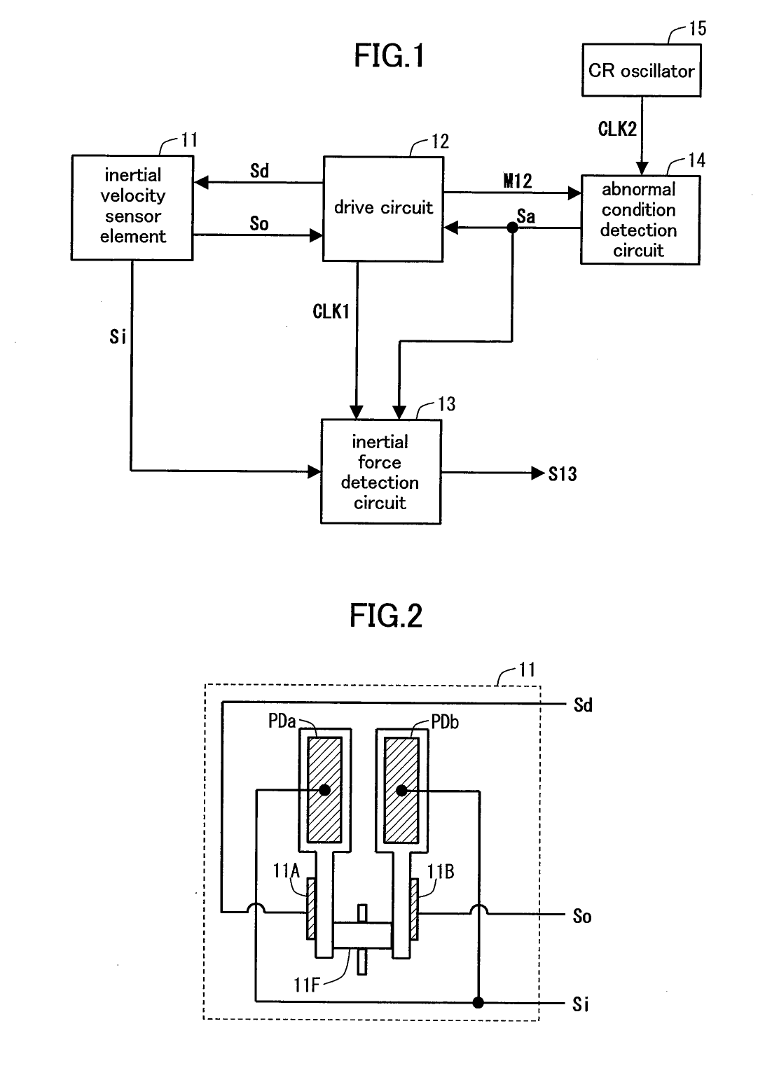

FIG. 1 shows a configuration of an inertial velocity sensor device according to Embodiment 1 of the present invention. The inertial velocity sensor device includes an inertial velocity sensor element 11, a drive circuit 12, an inertial force detection circuit 13, an abnormal condition detection circuit 14, and a CR oscillator 15.

<Inertial Velocity Sensor>

The inertial velocity sensor element 11 oscillates according to a frequency and an amplitude of a drive signal Sd from the drive circuit 12 to output an oscillation signal So corresponding to the oscillation, and outputs a sensor signal Si corresponding to an inertial force (e.g., Coriolis force) applied to the inertial velocity sensor element 11. For example, as shown in FIG. 2, the inertial velocity sensor element 11 includes a tuning-fork body 11F, a piezoelectric element 11A for drive, a piezoelectric element 11B for oscillation detection, and piezoelectric elements PDa and PDb for angular velocity detection. The tuning-fork body 11F includes a pair of tuning-fork pieces each twisted to a right angle at a middle part, a connecting part that connects one end of one of the tuning-fork pieces with one end of the other tuning-fork piece, and a support pin provided to the connecting part to serve as a rotation axis. The piezoelectric element 11A for drive oscillates the tuning-fork piece for drive according to the frequency and amplitude of the drive signal Sd from the drive circuit 12. As a result, resonance occurs between the tuning-fork piece for drive and the tuning-fork piece for detection. By this tuning-fork oscillation, electric charge is generated in the piezoelectric element 11B for oscillation detection (in other words, the oscillation signal So is generated). When an angular velocity is generated, electric charge according to Coriolis force is generated in the piezoelectric elements PDa and PDb for angular velocity detection (in other words, the sensor signal Si is generated).

<Drive Circuit>

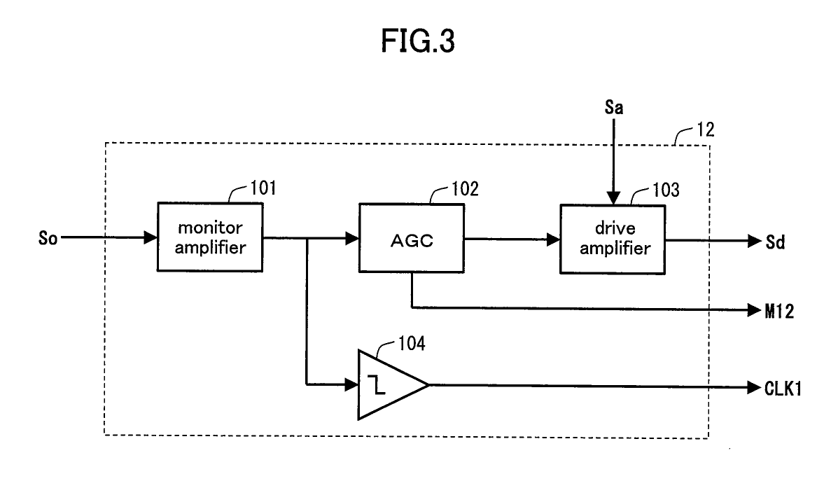

FIG. 3 shows an example internal configuration of the drive circuit 12 of FIG. 1. The drive circuit 12 adjusts the frequency and amplitude of the drive signal Sd according to the oscillation signal So from the inertial velocity sensor element 11. In the drive circuit 12, a monitor amplifier 101 converts the oscillation signal So from the inertial velocity sensor element 11 into voltage, and an automatic gain control (AGC) amplifier 102 changes its gain such that the voltage supplied to a drive amplifier 103 has a constant value. The drive amplifier 103 controls the amplitude of the drive signal Sd according to an output of the automatic gain control amplifier 102. By adjusting the drive signal Sd according to the oscillation signal So as in the above, a maximum oscillation amplitude and an oscillation frequency of the inertial velocity sensor element 11 are maintained constant. Further, a comparator 104 converts the oscillation signal So into a square-wave signal and outputs the square-wave signal as a clock signal CLK1.

<Inertial Force Detection Circuit>

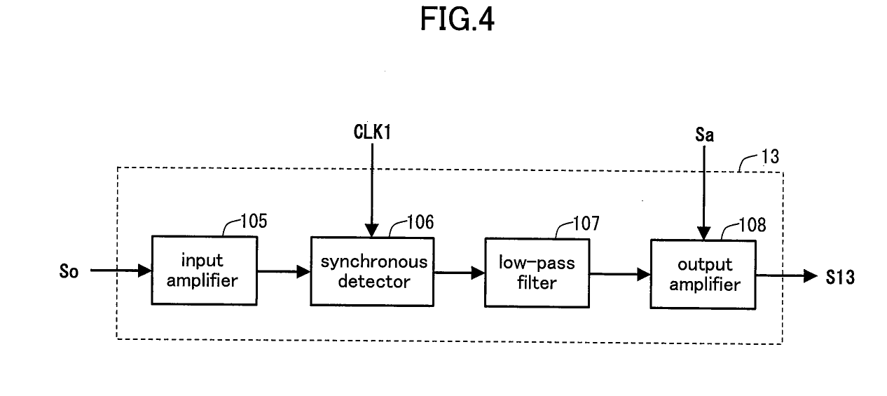

FIG. 4 shows an internal configuration of the inertial force detection circuit 13 of FIG. 1. The inertial force detection circuit 13 extracts an inertial force component (an analog signal corresponding to an inertial force applied to the inertial velocity sensor element 11) from the sensor signal Si output from the inertial velocity sensor element 11, using the clock signal CLK1 from the drive circuit 12 as an analog detection signal. In the inertial force detection circuit 13, an input amplifier 105 converts the sensor signal Si from the inertial velocity sensor element 11 into voltage, and a synchronous detector 106 extracts the inertial force component from an output of the input amplifier 105 using the analog detection signal (the clock signal CLK1 from the drive circuit 12). A low-pass filter 107 allows only a low-frequency component of the analog signal extracted by the synchronous detector 106 to pass for the purpose of such as removing noise, and an output amplifier 108 amplifies an output of the low-pass filter 107 and outputs the amplified signal as an inertial force detection signal S13 (analog value).

<Abnormal Condition Detection Circuit>

Turning back to FIG. 1, the abnormal condition detection circuit 14 determines whether the operating condition of the drive circuit 12 is normal or abnormal, based on a monitor signal M12 for monitoring the operating condition of the drive circuit 12. Further, the abnormal condition detection circuit 14 synchronizes with a clock signal CLK2 from the CR oscillator 15 to measure a period in which the operating condition of the drive circuit 12 is abnormal (an abnormal condition period), and outputs an abnormal condition detection signal Sa when the abnormal condition period obtained by the measurement reaches an abnormal condition detection period (a predetermined period). Each of the drive circuit 12 and the inertial force detection circuit 13 performs an error handling on receipt of the abnormal condition detection signal Sa from the abnormal condition detection circuit 14.

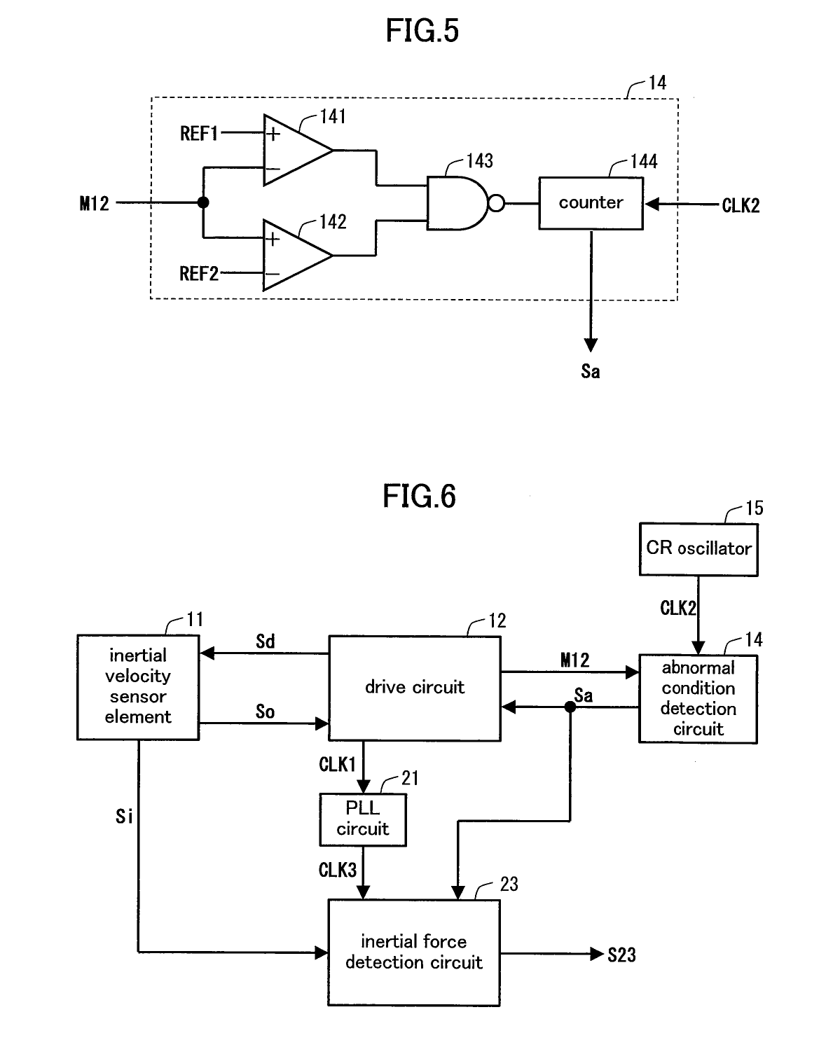

For example, in the case where the operating condition of the drive circuit 12 is monitored based on a direct-current voltage inside the automatic gain control amplifier 102 of the drive circuit 12, the abnormal condition detection circuit 14 includes, as shown in FIG. 5, a window comparator which is composed of comparators 141 and 142 and a NAND circuit 143, and a counter 144 which operates in synchronization with the clock signal CLK2 from the CR oscillator 15. Reference voltages REF1 and REF2 are for specifying a normal voltage range, and the reference voltage REF1 is higher than the reference voltage REF2. The abnormal condition detection circuit 14 determines that the operating condition of the drive circuit 12 is abnormal if a voltage value of the monitor signal M12 (a voltage value of the direct-current voltage inside the automatic gain control amplifier 102) is out of the normal voltage range specified by the reference voltages REF1 and REF2.

As described in the above, the abnormal condition detection circuit 14 operates in synchronization with the clock signal CLK2 from the CR oscillator 15 (e.g., a clock signal whose frequency is not based on a frequency of the inertial velocity sensor element 11), and not with a signal whose frequency is based on the frequency of the inertial velocity sensor element 11 (e.g., the clock signal CLK1). Thus, the abnormal condition detection circuit 14 can detect the abnormal condition of the drive circuit 12 even when the inertial velocity sensor element 11 is not in the normal operation.

The abnormal condition detection circuit 14 may be configured such that it can detect not only an abnormal condition of the drive circuit 12 but also abnormal conditions of other parts of the inertial velocity sensor device (such as the inertial force detection circuit 13).

<Error Handling>

Now, the error handlings by the drive circuit 12 and the inertial force detection circuit 13 are described.

In the drive circuit 12, the drive amplifier 103 gradually reduces the amplitude of the drive signal Sd on receipt of the abnormal condition detection signal Sa from the abnormal condition detection circuit 14. This makes it possible to suppress abrupt variations in the drive signal Sd and prevent destruction of the inertial velocity sensor element 11. The drive circuit 12 may be configured such that the drive amplifier 103 stops outputting the drive signal Sd when the abnormal condition detection signal Sa is output from the abnormal condition detection circuit 14.

In the inertial force detection circuit 13, the output amplifier 108 fixes a voltage value of the inertial force detection signal S13 on receipt of the abnormal condition detection signal Sa from the abnormal condition detection circuit 14. Alternatively, the output amplifier 108 gradually reduces the voltage value of the inertial force detection signal S13 on receipt of the abnormal condition detection signal Sa from the abnormal condition detection circuit 14. This makes it possible to suppress abrupt variations in the inertial force detection signal S13. The inertial force detection circuit 13 may be configured such that the output amplifier 108 stops outputting the inertial force detection signal S13 when the abnormal condition detection signal Sa is output from the abnormal condition detection circuit 14.

### Embodiment 2

FIG. 6 shows a configuration of an inertial velocity sensor device according to Embodiment 2 of the present invention. This inertial velocity sensor device includes an inertial force detection circuit 23 in place of the inertial force detection circuit 13 shown in FIG. 1, and further includes a PLL circuit 21 which generates an operation clock CLK3 by multiplying the clock signal CLK1 output from the drive circuit 12. The other parts of the configuration are the same as those in FIG. 1.

<Inertial Force Detection Circuit>

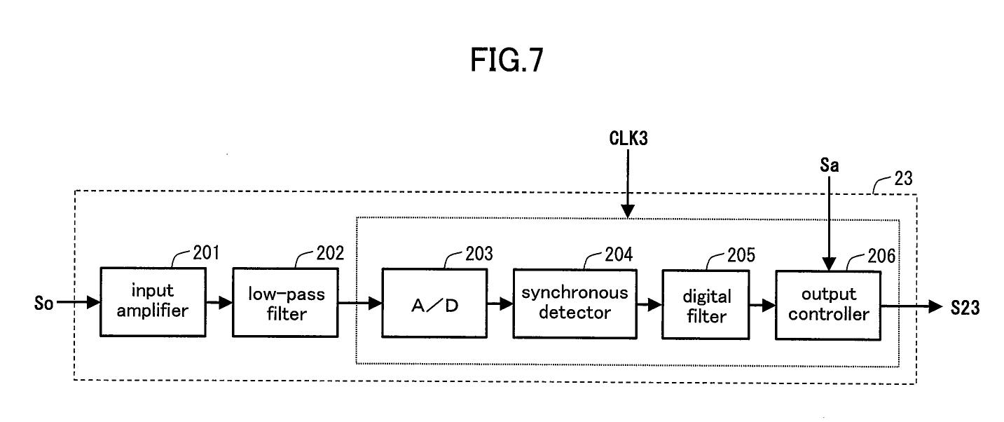

FIG. 7 shows an internal configuration of the inertial force detection circuit 23 of FIG. 6. The inertial force detection circuit 23 converts the sensor signal Si output from the inertial velocity sensor element 11 into a digital sensor signal, and then extracts an inertial force component (a digital signal corresponding to the inertial force applied to the inertial velocity sensor element 11) from the digital sensor signal, using a digital detection signal (a detection signal generated based on the operation clock CLK3 output from the PLL circuit 21). In the inertial force detection circuit 23, an analog/digital (A/D) converter 203, a synchronous detector 204, a digital filter 205, and an output controller 206 operate in synchronization with the operation clock CLK3 output from the PLL circuit 21.

An input amplifier 201 converts the sensor signal Si output from the inertial velocity sensor element 11 into voltage, and a low-pass filter 202 allows only a low-frequency component of an output of the input amplifier 201 to pass for the purpose of such as removing noise. The analog/digital converter 203 carries out an analog/digital conversion of an output of the low-pass filter 202, and thereby obtains a digital sensor signal. The synchronous detector 204 generates a digital detection signal based on the operation clock CLK3, and using the digital detection signal, extracts an inertial force component (a digital signal corresponding to an inertial force) from the digital sensor signal obtained by the analog/digital converter 203. The digital filter 205 allows only a low-frequency component of the digital signal extracted by the synchronous detector 204 to pass for the purpose of removing noise components. The output controller 206 outputs an output of the digital filter 205 as an inertial force detection signal S23 (digital value). Further, the output controller 206 gradually reduces the digital value indicated by the inertial force detection signal S23, on receipt of the abnormal condition detection signal Sa from the abnormal condition detection circuit 14. This makes it possible to suppress abrupt variations in the inertial force detection signal S23. The inertial force detection circuit 23 may be configured such that the output controller 206 stops outputting the inertial force detection signal S23 when the abnormal condition detection signal Sa is output from the abnormal condition detection circuit 14.

In the signal processing device disclosed in Patent Document 1, a digital detection signal is generated based on a clock signal from an oscillator circuit, while in the inertial velocity sensor device according to the present embodiment, the digital detection signal is generated using the oscillation signal So output from the inertial velocity sensor element 11. Digital detection signals in synchronization with the sensor signal Si can thus be easily generated, and alias and beat can be suppressed.

<Modification of Inertial Force Detection Circuit>

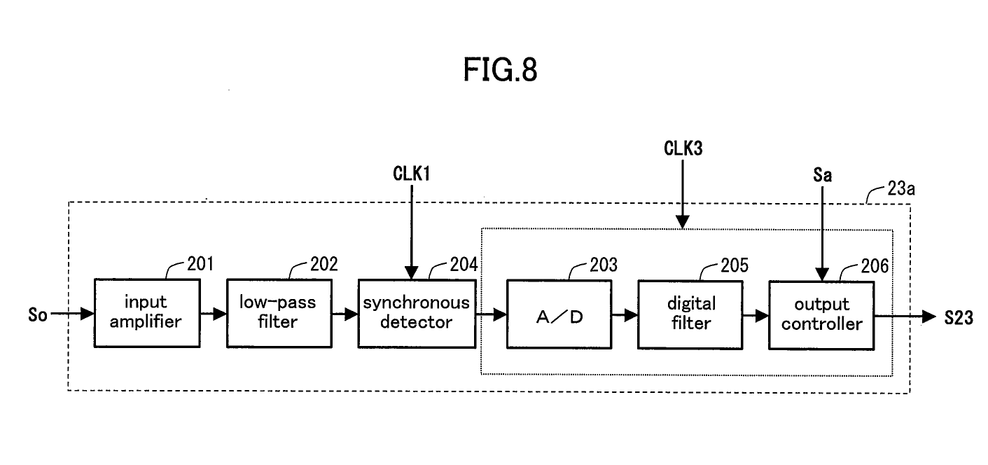

The inertial velocity sensor device of FIG. 6 may include an inertial force detection circuit 23a of FIG. 8 in place of the inertial force detection circuit 23. The inertial force detection circuit 23a shown in FIG. 8 extracts an inertial force component (an analog signal corresponding to an inertial force applied to the inertial velocity sensor element 11) from the sensor signal Si output from the inertial velocity sensor element 11, using an analog detection signal (the clock signal CLK1 from the drive circuit 12), and then converts the inertial force component into a digital signal. In the inertial force detection circuit 23a, the analog/digital (A/D) converter 203, the digital filter 205, and the output controller 206 operate in synchronization with the operation clock CLK3 from the PLL circuit 21. The synchronous detector 204 extracts an inertial force component of the output of a low-pass filter 202 using the clock signal CLK1 from the drive circuit 12, and outputs the inertial force component to the analog/digital converter 203.

### Embodiment 3

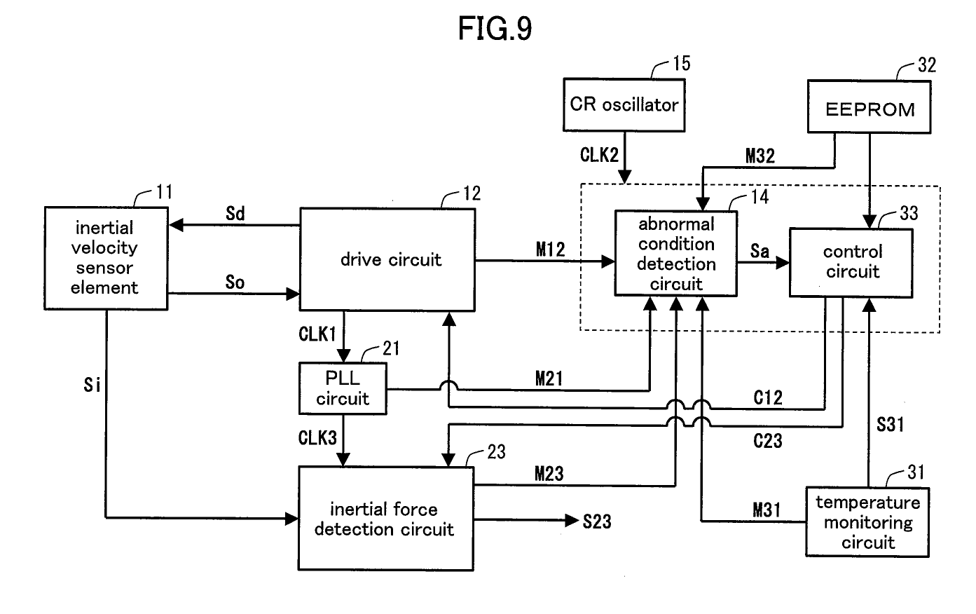

FIG. 9 shows a configuration of an inertial velocity sensor device according to Embodiment 3 of the present invention. This inertial velocity sensor device includes a temperature monitoring circuit 31, an EEPROM 32, and a control circuit 33 in addition to the configuration shown in FIG. 6. The abnormal condition detection circuit 14 detects not only an abnormal condition of the drive circuit 12, but also abnormal conditions of the PLL circuit 21, the inertial force detection circuit 23, the temperature monitoring circuit 31 and the EEPROM 32. Here, the drive circuit 12, the abnormal condition detection circuit 14, the PLL circuit 21, the inertial force detection circuit 23, the temperature monitoring circuit 31, and the control circuit 33 are included in the same semiconductor integrated circuit (or the same package).

<Abnormal Condition Detection Circuit>

The abnormal condition detection circuit 14 does not only receive the monitor signal M12 for monitoring the operating condition of the drive circuit 12, but also receives monitor signals M21, M23, M31 and M32 for monitoring the operating conditions of the PLL circuit 21, the inertial force detection circuit 23, the temperature monitoring circuit 31 and the EEPROM 32. The abnormal condition detection circuit 14 determines whether the operating conditions of the drive circuit 12, the PLL circuit 21, the inertial force detection circuit 23, the temperature monitoring circuit 31 and the EEPROM 32 are normal or abnormal based on the monitor signals M12, M21, M23, M31 and M32. The abnormal condition detection circuit 14 synchronizes with the clock signal CLK2 output from the CR oscillator 15 to measure a period in which the operating condition of the circuit is abnormal (an abnormal condition period), for each of the drive circuit 12, the PLL circuit 21, the inertial force detection circuit 23, the temperature monitoring circuit 31 and the EEPROM 32. Further, the abnormal condition detection circuit 14 outputs the abnormal condition detection signal Sa when the abnormal condition period of at least one of the drive circuit 12, the PLL circuit 21, the inertial force detection circuit 23, the temperature monitoring circuit 31 and the EEPROM 32 reaches an abnormal condition detection period (a predetermined period). The abnormal condition detection circuit 14 may be configured to output the abnormal condition detection signal Sa based on the determination result of the operating conditions, without measuring the abnormal operation period.

<Temperature Monitoring Circuit>

The temperature monitoring circuit 31 measures a temperature of the semiconductor integrated circuit (or the package) and outputs the measurement result as a temperature monitoring signal S31.

<EEPROM>

The EEPROM 32 stores control information for controlling the operation of the drive circuit 12 (such as an amplification factor and an offset of the automatic gain control amplifier 102) and control information for controlling the operation of the inertial force detection circuit 23 (such as an amplification factor and an offset of the output controller 206).

<Control Circuit>

The control circuit 33 operates in synchronization with the clock signal CLK2 output from the CR oscillator 15 and outputs control signals C12 and C23 for controlling the drive circuit 12 and the inertial force detection circuit 23 based on the temperature monitoring signal S31 from the temperature monitoring circuit 31, the control information stored in the EEPROM 32, and the abnormal condition detection signal Sa from the abnormal condition detection circuit 14.

For example, the control circuit 33 reads the control information from the EEPROM 32, and based on the control information, controls parameters (such as an amplification factor and an offset) of each of the drive circuit 12 and the inertial force detection circuit 23, thereby implementing normal operations of the drive circuit 12 and the inertial force detection circuit 23. Further, the control circuit 33 determines that the semiconductor integrated circuit has an abnormal temperature when the temperature indicated by the monitoring signal S31 exceeds a given temperature, and makes the drive circuit 12 and the inertial force detection circuit 23 perform error handlings. The control circuit 33 makes the drive circuit 12 and the inertial force detection circuit 23 perform error handlings, also when the control circuit 33 receives the abnormal condition detection signal Sa from the abnormal condition detection circuit 14.

The control circuit 33 may be configured such that the control circuit 33 carries out reset processing when the temperature indicated by the monitoring signal S31 exceeds a given temperature or when the abnormal condition detection signal Sa is output from the abnormal condition detection circuit 14. In the reset processing, the control circuit 33 temporarily stops the operations of the drive circuit 12 and the inertial force detection circuit 23 and rereads the control information from the EEPROM 32 to reset the parameters of each of the drive circuit 12 and the inertial force detection circuit 23. The above control enables a restart of normal operations of the drive circuit 12 and the inertial force detection circuit 23.

As described in the above, the control circuit 33 operates in synchronization with the clock signal CLK2 from the CR oscillator 15 (a clock signal whose frequency is not based on a frequency of the inertial velocity sensor element 11), and not with the signal whose frequency is based on a frequency of the inertial velocity sensor element 11 (e.g., the clock CLK3). The control circuit 33 can therefore control the drive circuit 12 and the inertial force detection circuit 23 even when the inertial velocity sensor element 11 is not in the normal operation.

Moreover, inclusion of the drive circuit 12, abnormal condition detection circuit 14, PLL circuit 21, inertial force detection circuit 23, temperature monitoring circuit 31, and control circuit 33 in the same semiconductor integrated circuit (or same package) eliminates the need for wiring on board and the need for interrupt control by a microcomputer. Further, placing the temperature monitoring circuit 31 and the abnormal condition detection circuit adjacent to each other can improve accuracy in detecting self-heating.

The inertial velocity sensor element 11 may also be included in the same semiconductor integrated circuit (or the same package) in which the drive circuit 12, abnormal condition detection circuit 14, PLL circuit 21, inertial force detection circuit 23, temperature monitoring circuit 31, and control circuit 33 are included. In other words, the inertial velocity sensor element 11 and the signal processing circuits (drive circuit 12, abnormal condition detection circuit 14, PLL circuit 21, inertial force detection circuit 23, temperature monitoring circuit 31, and control circuit 33) may be formed as different modules, or may be formed as SiP (System in Package) in which the inertial velocity sensor element 11 and the signal processing circuits are sealed in the same package, or as a module in which the inertial velocity sensor element 11 and the signal processing circuits are embedded together.

Same effects are obtained in the inertial velocity sensor device of FIG. 9 even if the inertial force detection circuit 23 is replaced with the inertial force detection circuit shown in FIG. 4 or FIG. 8.

### Other Embodiments

Although the example in which the CR oscillator 15 is included in the inertial velocity sensor device is described in the above embodiments, the CR oscillator 15 may be provided outside the inertial velocity sensor device. Specifically, the inertial velocity sensor device may be provided with a clock input terminal, and the clock signal CLK2 may be supplied to the abnormal condition detection circuit 14 and the control circuit 33 through the clock input terminal.

The shape of the inertial velocity sensor element 11 is not limited to a tuning-fork shape, but may be a regular triangle prism, square prism, ring and other shapes. The inertial velocity sensor element 11 may be composed of a plurality of inertial velocity sensor elements.

### INDUSTRIAL APPLICABILITY

As described in the above, an inertial velocity sensor device of the present invention can detect an abnormal condition even if an inertial velocity sensor element is not in the normal operation, and thus, is suitable as a device for detecting an inertial force in mobile units (such as aircrafts, automobiles, robots, and ships), mobile phones, cameras, video game equipment and others.

1. An inertial velocity sensor signal processing circuit which is used together with an inertial velocity sensor element, comprising:
a first signal processing circuit which operates with a first clock; and
a second signal processing circuit which operates with a second clock which does not synchronize with the first clock.

2. The inertial velocity sensor signal processing circuit of claim 1, wherein the first clock is supplied from a first oscillator circuit which operates based on a frequency of the inertial velocity sensor element.

3. The inertial velocity sensor signal processing circuit of claim 2, further comprising a clock input terminal to which the second clock is supplied,
wherein the second signal processing circuit receives the second clock supplied to the clock input terminal.

4. The inertial velocity sensor signal processing circuit of claim 2, further comprising a second oscillator circuit configured to supply the second clock,
wherein the second signal processing circuit receives the second clock from the second oscillator circuit.

5. An inertial velocity sensor device, comprising:
the inertial velocity sensor signal processing circuit of claim 1; and
the inertial velocity sensor element.

6. The inertial velocity sensor device of claim 5, wherein the second signal processing circuit outputs an abnormal condition detection signal when the second signal processing circuit detects an abnormal condition of the inertial velocity sensor device.

7. The inertial velocity sensor device of claim 6, further comprising an abnormal condition handling circuit controlled by the abnormal condition detection signal,
wherein the abnormal condition handling circuit operates with the second clock.

8. The inertial velocity sensor signal processing circuit of claim 1, wherein the first and second signal processing circuits are included in a same semiconductor device.

9. The inertial velocity sensor device of claim 5, wherein the first and second signal processing circuits are included in a same semiconductor device.

10. The inertial velocity sensor signal processing circuit of claim 1, wherein the first and second signal processing circuits are included in a same package.

11. The inertial velocity sensor device of claim 5, wherein the first and second signal processing circuits and the inertial velocity sensor element are included in a same package.

12. The inertial velocity sensor signal processing circuit of claim 1, wherein
the inertial velocity sensor element oscillates according to a drive signal to output an oscillation signal which corresponds to the oscillation, and outputs a sensor signal which corresponds to an inertial force applied to the inertial velocity sensor element,
the first signal processing circuit is a sensor circuit which operates in synchronization with the first clock whose frequency is based on a frequency of the oscillation signal from the inertial velocity sensor element, and
the second signal processing circuit is an abnormal condition detection circuit which operates in synchronization with the second clock whose frequency is not based on the frequency of the oscillation signal and which determines whether an operating condition of the sensor circuit is normal or abnormal to output an abnormal condition detection signal.

13. The inertial velocity sensor signal processing circuit of claim 12, wherein the abnormal condition detection circuit synchronizes with the second clock to measure a period in which the operating condition of the sensor circuit is abnormal, and outputs the abnormal condition detection signal when the period measured reaches a given abnormal condition detection period.

14. The inertial velocity sensor signal processing circuit of claim 12, further comprising a control circuit which operates in synchronization with the second clock and which controls the sensor circuit in response to the abnormal condition detection signal from the abnormal condition detection circuit.

15. The inertial velocity sensor signal processing circuit of claim 12, wherein the sensor circuit includes a drive circuit configured to control the drive signal based on the oscillation signal.

16. The inertial velocity sensor signal processing circuit of claim 15, wherein the sensor circuit includes an inertial force detection circuit which uses the first clock to detect the inertial force from the sensor signal.

17. The inertial velocity sensor signal processing circuit of claim 16, wherein
the inertial force detection circuit converts the sensor signal to a digital sensor signal in synchronization with an operation clock whose frequency is based on a frequency of the first clock, and extracts a digital signal corresponding to the inertial force from the digital sensor signal by using a digital detection signal whose frequency is based on the frequency of the first clock.

18. The inertial velocity sensor signal processing circuit of claim 16, wherein
the inertial force detection circuit extracts an analog signal corresponding to the inertial force from the sensor signal by using an analog detection signal whose frequency is based on the frequency of the oscillation signal, and converts the analog signal to a digital signal in synchronization with an operation clock whose frequency is based on the frequency of the first clock.

19. The inertial velocity sensor signal processing circuit of claim 12, further comprising an oscillator circuit which supplies the second clock.

20. The inertial velocity sensor signal processing circuit of claim 12, wherein the sensor circuit and the abnormal condition detection circuit are included in a same semiconductor circuit or a same package.

21. An inertial velocity sensor device, comprising:
the inertial velocity sensor signal processing circuit of claim 12; and
the inertial velocity sensor element.

22. The inertial velocity sensor device of claim 21, wherein the inertial velocity sensor element, the sensor circuit, and the abnormal condition detection circuit are included in a same semiconductor integrated circuit or a same package.
